(19) United States
(12) Patent Application Publication
(10) Pub. No.: US 2020/0122832 A1
(43) Pub. Date: Apr. 23, 2020

(54) MULTICOPTER WITH IMPROVED CRUISING PERFORMANCE

(71) Applicant: Stephen Morris, Sunnyvale, CA (US)

(72) Inventor: Stephen Morris, Sunnyvale, CA (US)

(21) Appl. No.: 16/654,430

(22) Filed: Oct. 16, 2019

Related U.S. Application Data
(60) Provisional application No. 62/747,302, filed on Oct. 18, 2018.

(51) Int. Cl. B64C 39/02; B64C 27/08; B64C 27/52

(52) U.S. Cl. CPC B64C 39/024; B64C 2201/108; B64C 27/52; B64C 27/08

(57) ABSTRACT

An aircraft can include a fuselage, a plurality of booms extending from the fuselage, and a plurality of rotors coupled to the fuselage via the plurality of booms. The plurality of rotors can comprise at least a pair of rotors arranged on each of the first side and the second side of the fuselage. Each pair of rotors can include a fore rotor and an aft rotor, and each rotor can be configured to tilt its corresponding axis of rotation. The fore rotor can be spaced from the fuselage by a fore distance and the aft rotor can be spaced from the fuselage by an aft distance different than the fore distance, where the fore and aft distances can be selected such that the circular rotor paths of the fore and aft rotors partially overlap along the spanwise direction.

### CROSS-REFERENCE TO RELATED APPLICATION

This application claims the benefit of U.S. Provisional Application No. 62/747,302, filed on Oct. 18, 2018. The disclosure of the above application is incorporated herein by reference in its entirety.

### FIELD

The present disclosure relates to multicopters and, more particularly, to an improved design for a multicopter with reduced drag and power, resulting in increased performance.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In a typical multicopter, a plurality of rotors are provided and arranged substantially equidistant and symmetrically from the center of gravity of the multicopter. For example, a quadcopter (a multicopter with four rotors) may arrange its rotors in an X-configuration. Typically, the locations of the rotors are constrained such that specific combinations of changes in rotor thrust will individually affect a roll, pitch, or yaw torque with no cross coupling of these axes. Further, the plane of the rotors may be fixed in the sense that they do not change orientation (or “tilt”) in relation to the body of the multicopter. In this manner such multicopters can be easily controlled to move in forward, backward, and sideward directions, as well as ascend and descend, by merely changing the speed of rotation of the individual rotors. Furthermore, yaw control may be provided in a similar manner.

For example, to provide forward movement the multicopter may decrease the speed of the rotors in the front (or “fore”) and correspondingly increase the speed of the rotors in the rear (or “aft”). As a result of such adjustments, the multicopter will tilt or tip forward and the rotors will provide a forward thrust to the multicopter. As the multicopter is tilted, the speed of the rotors may be increased to compensate for the lift force that has been translated to forward thrust in order to provide a substantially constant altitude. The tilt of the multicopter will generally increase as the speed of forward (or other directional) movement is increased as the thrust related to the speed of the rotors and the tilt.

As the multicopter tilts, however, the drag on the multicopter will increase as the profile of the body is more exposed to the air resistance. Further, the tilt of the rotors may result in negative interference of the air flow between the fore and aft rotors. As an example, the wake vorticity of the fore rotors may negatively interfere with the aft rotors, thereby resulting in an increase of power consumption during cruising.

Accordingly, it would be desirable to provide an improved design that addresses the above noted and other deficiencies of conventional multicopter design.

### SUMMARY

In various implementations of the present disclosure, an aircraft with an improved design is disclosed. The aircraft can include a fuselage, a plurality of booms extending from the fuselage, and a plurality of rotors coupled to the fuselage via the plurality of booms. The fuselage can define a longitudinal axis extending in a longitudinal direction from a fore to an aft of the aircraft and a spanwise axis extending in a spanwise direction normal to the longitudinal direction in a plane of the fuselage. The fuselage can also have a first side opposite a second side. At least one boom of the plurality of booms can extend from each of the first side and the second side of the fuselage. Further, the plurality of rotors can comprise at least a pair of rotors arranged on each of the first side and the second side of the fuselage. Each pair of rotors can include a fore rotor and an aft rotor, and each rotor can define an axis of rotation at a rotor hub and be configured to rotate around its axis of rotation to define a circular rotor path. Additionally, each rotor can be configured to tilt its corresponding axis of rotation.

In each pair of rotors, the fore rotor can be spaced from the fuselage by a fore distance in the spanwise direction and the aft rotor can be spaced from the fuselage by an aft distance in the spanwise direction different than the fore distance. In each pair of rotors, the fore distance and the aft distance can be selected such that the circular rotor paths of the fore and aft rotors partially overlap along the spanwise direction.

In additional or alternative implementations, the present disclosure is related to another aircraft with an improved design. The aircraft can include a fuselage, a plurality of booms extending from the fuselage, a plurality of rotors coupled to the fuselage via the plurality of booms, a plurality of electric motors to independently power the plurality of rotors, and a flight control processor configured to control tilting and speed of rotation of the plurality of rotors. The fuselage can define a longitudinal axis extending in a longitudinal direction from a fore to an aft of the aircraft and a spanwise axis extending in a spanwise direction normal to the longitudinal direction in a plane of the fuselage. Further, the fuselage can have a first side opposite a second side. At least one boom of the plurality of booms can extend from each of the first side and the second side of the fuselage.

The plurality of rotors can comprise at least a pair of rotors arranged on each of the first side and the second side of the fuselage, and each rotor can be configured to tilt its corresponding axis of rotation. Each pair of rotors can include a fore rotor and an aft rotor. Each rotor can define an axis of rotation at a rotor hub and be configured to rotate around its axis of rotation to define a circular rotor path. The flight control processor can control the tilting and speed of rotation of the plurality of rotors such that the fuselage is maintained within five degrees of level during cruising of the aircraft. Furthermore, in each pair of rotors, the fore rotor can be spaced from the fuselage by a fore distance in the spanwise direction and the aft rotor can be spaced from the fuselage by an aft distance in the spanwise direction different than the fore distance. The fore distance and the aft distance can be selected such that the circular rotor paths of the fore and aft rotors partially overlap along the spanwise direction.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a partial schematic view of a spinning rotor in a first position according to some implementations of the present disclosure;

FIG. 2A is a partial schematic top view of an example multicopter shown travelling in a direction;

FIG. 2B is a partial schematic side view of a rotor arrangement of the multicopter of FIG. 2A;

FIG. 2C is an example representation of the vortices shown in the Trefftz plane generated by the multicopter of FIG. 2A;

FIG. 2D is another example representation of the vortices shown in the Trefftz plane generated by the multicopter of FIG. 2A;

FIG. 3A is a partial schematic top view of an example multicopter according to some implementations of the present disclosure shown travelling in a direction;

FIG. 3B is a partial schematic side view of a rotor arrangement of the multicopter of FIG. 3A;

FIG. 3C is an example representation of the vortices shown in the Trefftz plane generated by the multicopter of FIG. 3A; and

FIG. 4 is an enlarged partial view of the multicopter of FIG. 3A.

### DETAILED DESCRIPTION

As previously discussed, a typical multicopter (which sometimes may be referred to as a drone) includes a plurality of rotors that are arranged symmetrically and substantially equidistant from the center of gravity of the multicopter. Such multicopters are designed such that they can be easily controlled to move forward, backward, and sideward, as well as ascend/descend and rotate about the vertical axis (yaw), by merely changing the speed of rotation of the individual rotors. For example only, in order to provide forward movement, the multicopter may decrease the speed of the rotors in the front (or “fore”) and correspondingly increase the speed of the rotors in the rear (or “aft”). As a result of such adjustments, the multicopter will tilt or tip forward and the rotors will provide a forward thrust to the multicopter. As the multicopter is tilted, the speed of the rotors may be balanced to compensate for the lift force that has been translated to forward thrust in order to provide a substantially constant altitude. The tilt of the multicopter will generally increase as the speed of forward (or other directional) movement is increased as the thrust is related to the speed of the rotors and the tilt.

As the multicopter tilts, however, the drag on the multicopter will increase as the profile of the body is more exposed to the air resistance. Further, the tilt of the rotors may result in negative interference of the air flow between the fore and aft rotors. As an example, the wake vorticity of the fore rotors may negatively interfere with the aft rotors, thereby resulting in an increase of power consumption during cruising.

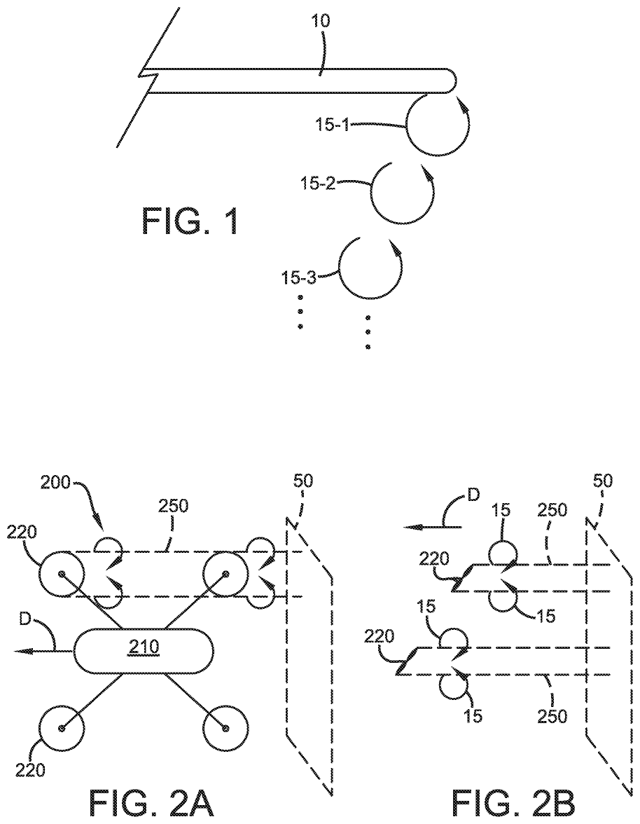

With reference to FIG. 1, a snapshot of a spinning rotor 10 is illustrated in a first position. As the rotor 10 spins, rotor tip vortices 15-1, 15-2, 15-3 . . . 15-n (hereinafter referred to as “vortex 15” or “vortices 15”) are generated. In the illustrated example, the rotor 10 is spinning into or out of the page. Accordingly, the vortices 15 are generated in a plane perpendicular to the rotational direction, that is, the plane of the page. These vortices 15 contribute to what is referred to as the induced drag of the multicopter and can increase the induced power of the multicopter.

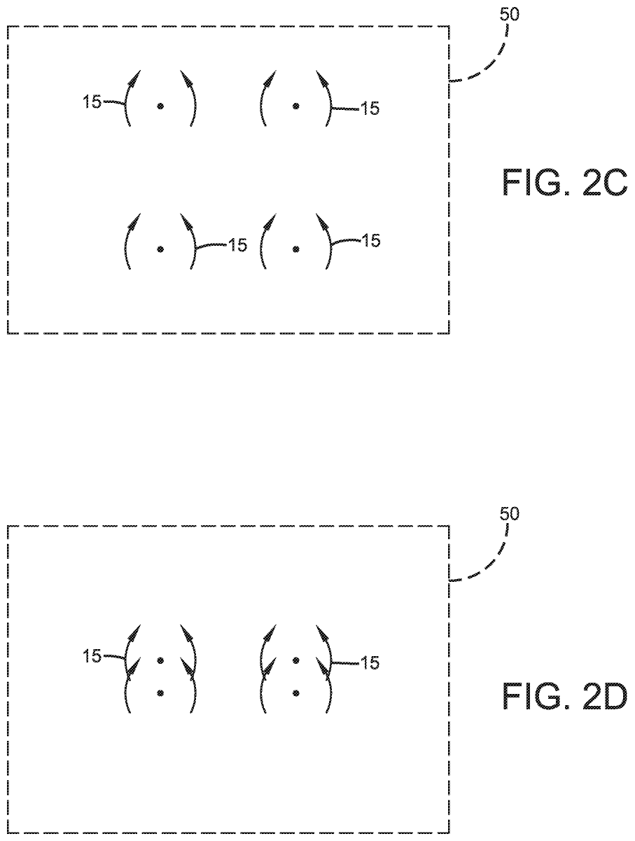

One measurement of the induced drag (or induced power) of a multicopter is an estimation of the energy left in the wake of the multicopter as measured in a plane perpendicular to the motion of the multicopter. This perpendicular plane is referred to as the Trefftz plane and the estimation is commonly referred to as Trefftz Plane Analysis. With reference to FIG. 2A-2D, a multicopter 200 is shown travelling in a direction D with its corresponding Trefftz plane 50. The multicopter 200 is illustrated as having a fuselage 210 and four rotors 220. The rotors 220 of the multicopter 200 are arranged symmetrically and substantially equidistant from the center of gravity of the multicopter 200 such that movement in the direction D is accomplished by merely changing the speed of rotation of the individual rotors 220. Further, the rotors 220 on each side of the multicopter 200 are arranged such that there is complete overlap of the rotor path 250 in the spanwise direction. Accordingly, the multicopter 200 will tilt or tip forward such that the rotors 220 will provide a forward thrust to the multicopter 200.

A side view of two of the rotors 220 of the multicopter 200 is shown in FIG. 2B, where the generated vortices 15 are also shown. FIG. 2C illustrates the generated vortices 15 shown in the Trefftz plane 50 by the multicopter 200 when travelling in the direction D. As shown, each rotor 220 will generate two vortices 15; thus, eight vortices 15 are shown in the Trefftz plane 50. As the induced drag and induced power of the multicopter 200 is related to these vortices 15, the eight vortices 15 illustrated in FIG. 2C will each fully contribute to the induced drag. Additionally, in the event that the tilt of the multicopter 200 is not as pronounced as illustrated in FIG. 2C while moving in direction D, the upper and lower vortices 15 may overlap in the Trefftz plane 50 (see FIG. 2D) and thereby provide an increased vortex 15 strength due to additive (and, in this case, negative) interference.

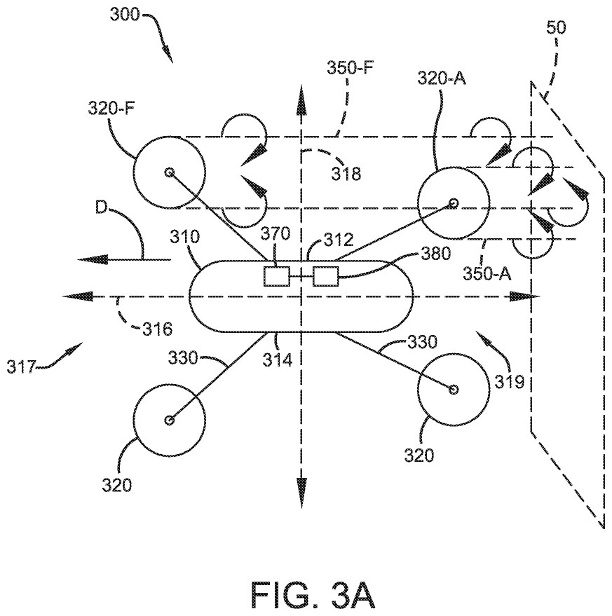

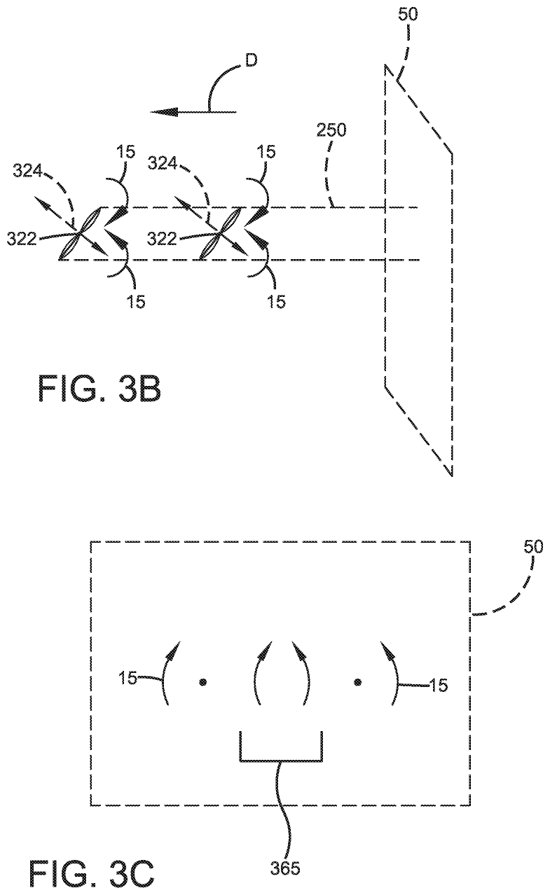

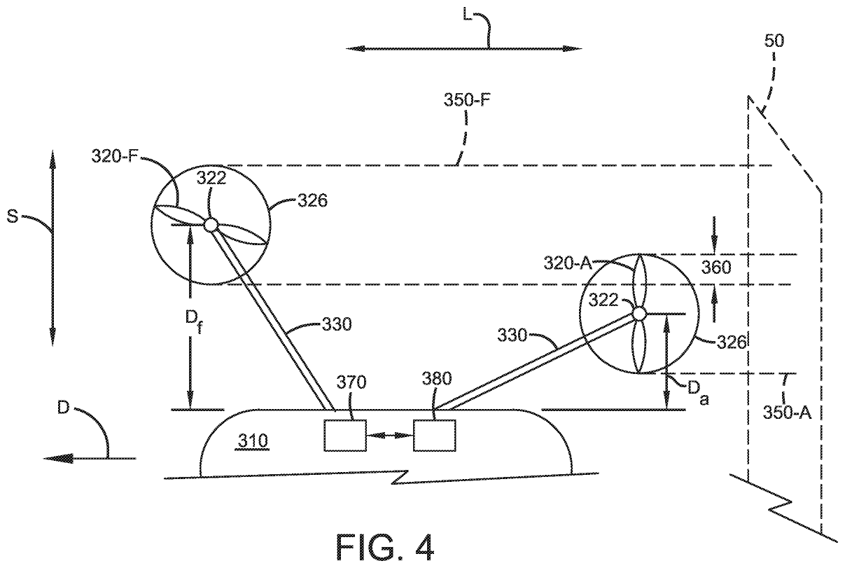

With reference to FIGS. 3A-3C and 4, an improved multicopter 300 according to various aspects of the present disclosure is shown. The multicopter 300 includes a fuselage 310 and a plurality of rotors 320. The fuselage 310 can define a longitudinal axis 316 extending in a longitudinal direction L (see FIG. 4) from a fore 317 to an aft 319 of the multicopter 300. A spanwise axis 318 can also be defined normal to the longitudinal axis 316, which extends in a spanwise direction S in a plane of the fuselage 310 (see FIG. 4). The plurality of rotors 320 can be coupled to the fuselage 310 via a plurality of booms 330. Each of the booms 330 can extend from the fuselage 310 at one end to a corresponding rotor 320 at the other end. In some implementations, at least one boom 330 can extend from each of a first side 312 and a second side 314 of the fuselage 310. Each of the booms 330 can be fixed and non-tilting or, alternatively, can be capable of being tilted, e.g., forwards and backwards, to correspondingly tilt its corresponding rotor 320 as more fully described below.

The plurality of rotors 320 can include at least a pair of rotors 320 arranged on each of the first and second sides 312, 314 of the fuselage 310. For example only, the illustrated multicopter 300 is shown as having four rotors 320 and corresponding booms 330. It should be appreciated, however, that other configurations of the multicopter 300 are within the scope of the present disclosure. Such additional configurations include, but are not limited to, a single boom 330 with a pair or multiple pairs of rotors 320 on each side 312, 314 of the fuselage 310, and a fuselage 310 with eight total rotors 320 (four on each side) and one or more booms on each side 312, 314. While the described example multicopter 300 is shown as having a single rotor for each rotor 320 shown, the teachings of the present disclosure are applicable, mutatis mutandis, to multicopter designs that utilize groups of rotors 320 that are “stacked” or otherwise grouped in pairs and the rotors spin opposite each other about the same axis.

The pair of rotors 320 on each side 312, 314 of the multicopter 300 shown in FIG. 3A includes a fore rotor 320-F and an aft rotor 320-A. The fore rotor 320-F will be arranged towards the fore of the multicopter 300, and the aft rotor 320-A will be arranged towards the aft of the multicopter 300. With additional reference to FIG. 4, each rotor 320 include a rotor hub 322 that defines an axis of rotation 324. Each rotor 320 is configured to rotate around its axis of rotation 324 to define a circular rotor path 326. Further, each rotor 320 can be configured to tilt its corresponding axle of rotation 324, e.g., with respect to the boom 330. In additional or alternative implementations, a boom 330 may be configured to tilt its corresponding rotor's 320 axle of rotation 324.

Each of the rotors 320 will be spaced from the fuselage 310 of the multicopter 300 by a distance. In each pair of rotors 320, the fore rotor 320-F will be spaced from the fuselage 310 in the spanwise direction S by a fore distance D_{f} and the aft rotor 320-A will be spaced from the fuselage 310 in the spanwise direction S by an aft distance Dₐ. The fore distance D_{f} and the aft distance Dₐ can be different such that the fore rotor 320-F and the aft rotor 320-A do not completely overlap in the longitudinal direction L.

Each rotor 320 can define a rotor path 350 that can be defined as the path of travel of the rotor 320 through space as the multicopter 300 moves in direction D. For example only, FIGS. 3A, 3B, and 4 illustrate the rotor path 350 of each of the rotors 320, where rotor path 350-F corresponds to fore rotor 320-F and rotor path 350-A corresponds to aft rotor 320-A. As shown, e.g., in FIG. 4, the rotor paths 350-F, 350-A partially overlap an overlap amount 360 in the spanwise direction S. This offset configuration can result in beneficial interference of the vortices 15, as further described below.

With particular reference to FIG. 3B, a side view of a pair of the rotors 320 on one side of the multicopter 300 is shown, where the generated vortices 15 are also shown. In this figure, the multicopter 300 is travelling in the direction D. As mentioned, this can accomplished by tilting the axes 324 of the rotors 320 forward (by tilting the rotors 320 and/or the booms 330) such that the thrust of the rotors 320 is partially directed rearwardly (the opposite of direction D). From this viewpoint, it appears that the rotor paths 350 of the rotors 320 overlap completely. However, when viewed from the viewpoint of FIG. 3A or FIG. 4, the rotor paths 350-F, 350-A partially overlap an overlap amount 360 in the spanwise direction S. As mentioned above, the tilting of the axes 324 of the rotors 320 can be accomplished by tilting the rotors 320 and/or the booms 330. For simplicity of description, and unless otherwise clarified, when the present disclosure describes tilting of the axes 324 of the rotors 320 this should be interpreted to encompass tilting the rotors 320, tilting the booms 330, and tilting both the rotors 320 and the booms 330 in combination.

FIG. 3C illustrates the corresponding generated vortices 15 shown in the Trefftz plane 50 by the pair of the rotors 320 of multicopter 300 when travelling in the direction D. As shown, each rotor 320 will generate two vortices 15; thus, four vortices 15 are shown in the Trefftz plane 50 of FIG. 3C. As mentioned above, the induced power of the multicopter 300 is related to these vortices 15. Because of the overlap of the rotor paths 350, two of the vortices 15 can overlap and interfere with each other at a location 365. Due to the opposite rotation of the interfering vortices 15 that overlap at location 365, the interference will reduce (e.g., completely eliminate) the energy left in the Trefftz plane 50 from the interfering vortices 15. In such situations, this beneficial interference can thereby reduce the induced drag and/or induced power on the multicopter 300 during movement in the direction D.

In order to provide the beneficial interference described above, the fore distance D_{f} and the aft distance Dₐ can be selected to provide the appropriate overlap amount 360 of the rotor paths 350 in the spanwise direction S. In some aspects, the overlap amount 360 can be between 0 and 50% of the length of the rotor 320. In other examples, the overlap amount 360 can be between 18 and 30% of the length of the rotor 320. It should be appreciated, however, that other overlap amounts 360 can be utilized and still fall within the scope of the present disclosure.

In some aspects, the multicopter 300 can also include a flight control processor 370 and/or a radio receiver 380. The flight control processor 370 can be configured to automatically control the tilting and speed of rotation of each of the plurality of rotors 320, e.g., based on control instructions. The control instructions can be output from a remote control (not shown) of a user and received by the radio receiver 380. Furthermore, the flight control processor 370 can receive the control instructions from radio receiver 380. It should be appreciated that the multicopter 300 can be controlled in other manners than the above.

Movement of the multicopter 300 of the present disclosure can be achieved by controlling the speed of rotation and tilt of the axes of rotation 324 of the rotors 320. In various implementations, the flight control processor 370 can control the tilting and speed of rotation of the plurality of rotors 320. For example only, the multicopter 300 can further include a plurality of electric motors (not shown) to independently power (e.g., rotate) the plurality of rotors 320 and a plurality of servos or other motion control mechanisms (not shown) to control the tilt of the rotors 320.

Because of the asymmetrical configuration of the rotors 320 in the multicopter 300, typical multicopter control strategies may be insufficient to properly provide flight control. Accordingly, yaw control for the multicopter 300 may be provided by tilting the plurality of rotors 320, e.g., in an asymmetrical fashion. Further, forward and rear motion of the multicopter 300 may be controlled by tilting the plurality of rotors 320. Pitch and roll control, as an example, may be provided by modulating power delivered to the plurality of rotors 320.

In various implementations of the present disclosure, the total drag of the multicopter 300 may be further reduced through various design and control arrangements. Because the rotors 320 can be tilted independently of the booms 330 and fuselage 310, and the multicopter 300 itself may be able to better maintain a constant attitude during flight/cruising. Therefore, the fuselage 310 and/or booms 330 can be configured to have a more aerodynamic profile in the intended attitude, thereby reducing the aerodynamic drag during flight. For example only, the flight control processor 370 may automatically control the tilting and speed of the rotors 320 such that the fuselage 310 is maintained within five degrees of level during cruising.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term processor or module may refer to, be part of, or include: an Application Specific Integrated Circuit (ASIC); an electronic circuit; a combinational logic circuit; a field programmable gate array (FPGA); a processor or a distributed network of processors (shared, dedicated, or grouped) and storage in networked clusters or datacenters that executes code or a process; other suitable components that provide the described functionality; or a combination of some or all of the above, such as in a system-on-chip. The term module may also include memory (shared, dedicated, or grouped) that stores code executed by the one or more processors.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An aircraft, comprising:
a fuselage defining a longitudinal axis extending in a longitudinal direction from a fore to an aft of the aircraft and a spanwise axis extending in a spanwise direction normal to the longitudinal direction in a plane of the fuselage, the fuselage having a first side opposite a second side;
a plurality of booms extending from the fuselage, wherein at least one boom of the plurality of booms extends from each of the first side and the second side of the fuselage; and
a plurality of rotors coupled to the fuselage via the plurality of booms, the plurality of rotors comprising at least a pair of rotors arranged on each of the first side and the second side of the fuselage,
wherein:
each pair of rotors includes a fore rotor and an aft rotor,
each rotor defines an axis of rotation at a rotor hub and is configured to rotate around its axis of rotation to define a circular rotor path,
each rotor is configured to tilt its corresponding axis of rotation,
in each pair of rotors, the fore rotor is spaced from the fuselage by a fore distance in the spanwise direction and the aft rotor is spaced from the fuselage by an aft distance in the spanwise direction different than the fore distance, and
in each pair of rotors, the fore distance and the aft distance are selected such that the circular rotor paths of the fore and aft rotors partially overlap along the spanwise direction.

2. The aircraft of claim 1, wherein in each pair of rotors, the fore distance and the aft distance are selected such that the circular rotor paths of the fore and aft rotors partially overlap along the spanwise direction by between 0 and 50%.

3. The aircraft of claim 2, wherein in each pair of rotors, the fore distance and the aft distance are selected such that the circular rotor paths of the fore and aft rotors partially overlap along the spanwise direction by between 18 and 30%.

4. The aircraft of claim 1, wherein yaw control is provided by tilting the plurality of rotors.

5. The aircraft of claim 4, wherein yaw control is provided by asymmetrical tilting of the plurality of rotors.

6. The aircraft of claim 1, wherein forward and rear motion are provided by tilting the plurality of rotors.

7. The aircraft of claim 1, wherein attitude control is provided by modulating power delivered to the plurality of rotors.

8. The aircraft of claim 1, wherein roll control is provided by modulating power delivered to the plurality of rotors.

9. The aircraft of claim 1, wherein the plurality of booms comprises at least one non-tilting, fixed boom.

10. The aircraft of claim 1, wherein the plurality of booms comprises at least one boom configured to tilt.

11. An aircraft, comprising:
a fuselage defining a longitudinal axis extending in a longitudinal direction from a fore to an aft of the aircraft and a spanwise axis extending in a spanwise direction normal to the longitudinal direction in a plane of the fuselage, the fuselage having a first side opposite a second side;
a plurality of booms extending from the fuselage, wherein at least one boom of the plurality of booms extends from each of the first side and the second side of the fuselage;
a plurality of rotors coupled to the fuselage via the plurality of booms, the plurality of rotors comprising at least a pair of rotors arranged on each of the first side and the second side of the fuselage, each rotor being configured to tilt its corresponding axis of rotation;
a plurality of electric motors to independently power the plurality of rotors; and
a flight control processor configured to control tilting and speed of rotation of the plurality of rotors,
wherein:
each pair of rotors includes a fore rotor and an aft rotor,
each rotor defines an axis of rotation at a rotor hub and is configured to rotate around its axis of rotation to define a circular rotor path, and
the flight control processor controls the tilting and speed of rotation of the plurality of rotors such that the fuselage is maintained within five degrees of level during cruising of the aircraft, and
in each pair of rotors, the fore rotor is spaced from the fuselage by a fore distance in the spanwise direction and the aft rotor is spaced from the fuselage by an aft distance in the spanwise direction different than the fore distance, the fore distance and the aft distance being selected such that the circular rotor paths of the fore and aft rotors partially overlap along the spanwise direction.

12. The aircraft of claim 11, wherein in each pair of rotors, the fore distance and the aft distance are selected such that the circular rotor paths of the fore and aft rotors partially overlap along the spanwise direction by between 0 and 50%.

13. The aircraft of claim 12, wherein in each pair of rotors, the fore distance and the aft distance are selected such that the circular rotor paths of the fore and aft rotors partially overlap along the spanwise direction by between 18 and 30%.

14. The aircraft of claim 1, wherein yaw control is provided by tilting the plurality of rotors.

15. The aircraft of claim 14, wherein yaw control is provided by asymmetrical tilting of the plurality of rotors.

16. The aircraft of claim 11, wherein forward and rear motion are provided by tilting the plurality of rotors.

17. The aircraft of claim 11, wherein the plurality of booms comprises at least one non-tilting, fixed boom.

18. The aircraft of claim 11, wherein the plurality of booms comprises at least one boom configured to tilt.

19. The aircraft of claim 11, further comprising a radio receiver configured to receive control instructions from a remote control.

20. The aircraft of claim 19, wherein the flight control processor is configured to receive the control instructions from the radio receiver and automatically control the tilting and speed of rotation of the plurality of rotors such that the fuselage is maintained within five degrees of level during execution of the control instructions.
